(19) United States
(12) Patent Application Publication
(10) Pub. No.: US 2013/0105385 A1
(43) Pub. Date: May 2, 2013

(54) CARBON BLOCK FILTER FORMED FROM DIVIDED PARTICLES OF BINDER AND ACTIVATED CARBON AND METHOD THEREFOR

(71) Applicant: Hyuk-won KWON, Daejeon (KR)

(72) Inventor: Hyuk-won KWON, Daejeon (KR)

(73) Assignee: ALTWELLTECH INC., Daejeon (KR)

(21) Appl. No.: 13/476,223

(22) Filed: May 21, 2012

(30) Foreign Application Priority Data
Oct. 26, 2011 (KR) 1020110109976

(51) Int. Cl. B01D 39/00; B29C 67/24

(52) U.S. Cl. 210/502.1; 264/109

(57) ABSTRACT

A carbon block filter with UHMWPE binders and activated carbons and the method are provided. The method comprises: pulverizing ultrahigh molecular weight polyethylene (UHMWPE) binders with an average particle size of 120˜140 μm, serving as original binders, and separating binders with a granularity of 20˜80 μm from the original binders; mixing the separated binders with the original binders; and forming a carbon block filter by mixing commercial, powdered activated carbons, with the mixed binders. The mixing of the separated binders with the original binders and the forming of the carbon block filter control the powdered activated carbons and the adjusted, UHMWPE binders so that the cumulative granularity ratio of them is 1:0.78˜1.1, with respect to a particle size equal to or less than 105 μm.

### BACKGROUND OF THE INVENTION

1. Field of the Invention

This invention relates to a carbon block filter that comprises ultra high molecular weight polyethylene (UHMWPE) binders and activated carbons, where the granularity ratio is 1:0.78˜1.1, with respect to the particle size equal to or less than 105 μm, by controlling the ratio of mixing the pulverized binders with the activated carbons, so that the filter has a high level of performance and is manufactured at a relatively low cost. The invention also relates to a method for manufacturing the carbon block filter.

2. Description of the Related Art

Conventional activated carbon filters used for water purifiers are designed to fill with powdered activated carbons. The filters filter and adsorb impurities while water flows therethrough. However, since they are just configured to fill with powdered activated carbons, the filter layers create a channel phenomenon. This decreases the removal efficiency of impurities and causes the continuance outflow of the activated carbons.

Since the activated carbons are coated with low-density polyethylene (LDPE) binders and high-density polyethylene (HDPE) binders that have low viscosity and high mobility over the respective melting points, filters with coated activated carbons cannot guarantee their porosity and adsorption. Although LDPE binders with high mobility over the melting point of 80° C. are used to manufacture filters via a pressing method, they clog the surface of the activated carbons and thus reduce the adsorption area. In that case, the filters have difficulty controlling the pores and thus reduce the filter performance.

In order to resolve the problem, porous adsorption filters have been developed in such a way that ultra high molecular weight polyethylene (UHMWPE) binders and powdered activated carbons where the granularity is controlled are mixed and sintered in a certain ratio, which creates a high level of adsorption. The filters are called ‘carbon block filters.’ Most water purifiers employ carbon block filters because they have high filtration performance. UHMWPE binders with a thermoplastic characteristic refer to polyethylene that has a molecular weight equal to or greater than 10⁶ g/mol, a higher melting point than general polyethylene, and a low mobility over the melting point because the viscosity is high. If UHMWPE binders are mixed and sintered with powdered activated carbons with adsorption, they melt parts of the activated carbon particles and are bound with them, thereby manufacturing a hard carbon block filter, minimally reducing the adsorption of activated carbons.

The conventional carbon block filters are manufactured in a press molding method due to the characteristic of the binders. The filters have a high adsorption performance and a high porosity, which exerts a high filtration performance.

The press molding method is used to manufacture block filters with a high performance since it enables the filters to have a high adsorption and to efficiently control the porosity.

Conventional technology mixes binders with powdered activated carbons where the granularity is artificially controlled in a certain ratio and forms blocks with compression, thereby creating pores on the blocks. This does not produce a high quality carbon block filter. Conventional technology does not form fine powdered activated carbons. That is, although fine powdered activated carbons are formed, the carbon particles are separated from the surface, and this deteriorates the product value.

Carbon block filters manufactured by a compression molding method are formed in such a way that UHMWPE binders are mixed with powdered activated carbon particles where the granularity is controlled for the purpose of controlling the pores, in a certain ratio. During the process, the UHMWPE binders serve to connect the activated carbon particles. Therefore, the granularity of the binders and the activated carbons and the filling pressure affect the creation of the pores in the filter. However, the granularity rates of UHMWPE binders differ from each other according to the manufacturing process.

Therefore, since the granularities of activated carbons and binders are not uniform, the carbon block manufacturers cannot manufacture filters with fine structures, which cause the activated carbon particles to leak out of the filters. Therefore, the filters deteriorate the filtration performance.

Korean Patent Application No. 10-2001-7003737, Ticona, Germany, discloses polyethylene polymers with a melt index (MFR 190/15) of 1.4˜3 g/10 min, a distribution of 4˜8, a bulk density ranging from 0.15˜0.28 g/cm³, and a particle size ranging from 80 to 160 μm. Ticona's activated carbon filter is manufactured via a compression molding method and has high filtration performance. Ticona's polyethylene binders have been recognized so that the forming feature, the adsorption and the amount of flowing water are high.

However, filters using Ticona's binders are disadvantageous in that fine powdered particles are separated from the activated carbons.

In addition, the binders are very expensive, so that they increase the manufacturing cost of the filters. Therefore, it is necessary to create a cost-effective carbon block filter and manufacturing method.

### SUMMARY OF THE INVENTION

The invention has been made in view of the above problems, and provides a carbon block filter, with high filtration performance and high adsorption, using UHMWPE binders. The binders are used for engineering plastics. The binder has the following physical properties: a melting point of 130.1° C.; a bulk density ranging from 0.45˜0.55 g/cm³; a molecular weight ranging from 4.5˜6×10⁶ g/mol; and an average particle size ranging from 120˜140 μm. The binders (e.g., produced by Dae Han Oil Chemical, R.O.K.) refer to UHMWPE binders that are used to manufacture engineering plastics, high functional fibers, sports goods, etc., and have an average particle size ranging from 120˜140 μm. Meanwhile, since conventional UHMWPE binders with conventional physical properties differ from the powdered activated carbons in terms of granularity, they have not been used together to manufacture a carbon block filter with a high filtration performance.

In accordance with an exemplary embodiment of the invention, the invention provides a carbon block filter with a high filtration performance. The physical property of materials used for a filter and the filtration principle can be used to effectively control the pores of a block filter when the filter is manufactured by filing with the particle filter materials and the configuration of multi-layers is applied to the compositions of the carbon block filter. The invention provides an optimal design condition for controlling the pores of the block filter.

Conventional art has not attempted to design a carbon block filter and analyze the principles, based on a theoretical approach such as the principles of the invention. The most ideal filter using two types of filter materials can be designed in such a way that the upper layer includes filter materials with large-sized particles and small specific gravity and the upper layer includes filter materials with small-sized particles and large specific gravity. On the contrary, if the filter is designed in such a way that the upper layer includes filter materials with small-sized particles and small specific gravity and the lower layer includes filter materials with large-sized particles and large-specific gravity, the filtration performance is lower. However, the two types of filters are theoretical examples and are not actually manufactured. Therefore, filters, designed in such a way that two types of filter materials have similar physical properties in granularity distribution and specific gravity and are evenly mixed, have more efficient performance and longer filtration capacity than filters designed in such a way that two types of filter materials have a large difference in granularity distribution and specific gravity. That is, the invention provides the former filters.

Although a carbon block filter is manufactured via a principle that differs from that of a filter filling with particles, they operate using the same physical filtration principle. The carbon block filter according to the invention is formed in such a way that activated carbon grains are mixed with binders in a certain ratio, based on the optimal granularity distribution therebetween, thereby providing a high filtration performance.

In order to improve the method for manufacturing conventional pressing carbon block filters and to control the physical pores of the carbon blocks, the invention provides an optimal method for manufacturing carbon blocks where the pores have a size of 0.5, 1˜3, and 5 μm, in such a way as to identify that: the pore size is 0.5, 1˜3, 5 μm in order to purify tap water; the pore for grain filters is controlled; commercial activated carbons are pulverized; and the optical granularity distribution between the pulverized activated carbons and the binders where the granularity is artificially controlled is produced to acquire a theoretical numeral value.

The invention provides a carbon block filter where the UHMWPE binders is pulverized via a granularity control technology and the pulverized binders are mixed with powdered activated carbons so that the cumulative ratio of the pulverized binders and powdered activated carbons is 1:0.78˜1.1 with respect to the particle size equal to or less than 105 μm. The invention also provides an optimal ratio of composite for the carbon block filter. The performance of the carbon block filter is examined by analyzing the performance of the produced block filter.

The carbon block filter according to the invention is advantageous in that the binder materials, which have previously been imported from foreign counties to the R.O.K., are produced 100% locally in the R.O.K, thereby acquiring import substitution effect and reducing the manufacturing cost by 3040%.

### BRIEF DESCRIPTION OF THE DRAWINGS

The features and advantages of the invention will become more apparent from the following detailed description viewed in conjunction with the accompanying drawings, in which:

FIG. 1 illustrates a photograph of 60 times enlarged carbon blocks with pores of 3 μm according to an embodiment of the invention;

FIG. 2 illustrates a photograph of 60 times enlarged carbon blocks with pores of 3 μm according to the conventional art;

FIG. 3 illustrates a photograph of 300 times enlarged carbon blocks with pores of 3 μm according to an embodiment of the invention;

FIG. 4 illustrates a photograph of 300 times enlarged carbon blocks with pores of 3 μm according to another embodiment of the invention;

FIG. 5 illustrates a distribution-cumulative distribution graph of a binder manufactured by D company, R.O.K., according to the conventional art;

FIG. 6 illustrates a distribution-cumulative distribution graph of a binder mixing the original binders with separated binders, according to the invention; and

FIG. 7 illustrates a distribution-cumulative distribution graph of powdered activated carbons used in the carbon block filter according to the invention.

### DETAILED DESCRIPTION OF EXEMPLARY EMBODIMENTS

Hereinafter, exemplary embodiments of the invention are described in detail with reference to the accompanying drawings.

### Example 1

Composition of 3 μm Carbon Blocks and the Manufacturing Method

Powdered activated carbons with an average particle size ranging from 60˜102 μm are mixed with separated binders with a granularity of 20˜80 μm. The powdered activated carbons are 10˜20 wt % of the total amount of binders. The mixtures are compressed at approximately 3˜30 kgf/cm², and thermally processed at 230° C. for 30 minutes. After completing the processes, blocks with pores of approximately 3 μm are produced. The amount of binders in the block filter is 30˜35 wt %.

Analysis Result
1. Removal rate of chloroform (%)

1) Used pulverized binders (Block size: 41×21×195), made in D company (Dae Han Oil Chemical, R.O.K.)
D company's binder-1 (SAMPLE 1): 76.5% (700 liters)
D company's binder-2 (SAMPLE 2): 81.8% (700 liters)

2) Used binders (Block size: 41×21×195), made in T company (Ticona, Germany)
T company's binder-1 (SAMPLE 1): 62.5% (700 liters)
Where T company's binder-1 refers to a block filter where T company's binders are mixed with commercial activated carbons.
2. Comparisons of the amount of passing water, the rate of passing water, and the removal rate of chloroform.

TABLE 1

| Amount of | Amount of passing | | | Rate of passing water | | | Removal rate of | | |
|---|---|---|---|---|---|---|---|---|---|
| passing | water (L) | | | (%) | | | chloroform (%) | | |
| water | D Co. 1 | D Co. 2 | T Co. | D Co. 1 | D Co. 2 | T Co. | D Co. 1 | D Co. 2 | T Co. |
| 0 | 4.5 | 4.4 | 4.5 | 90.0 | 88.0 | 90.0 | 99.2 | 99.2 | 99.2 |
| 100 | 4.5 | 4.4 | 4.5 | 90.0 | 88.0 | 90.0 | 99.2 | 99.2 | 99.2 |
| 500 | 4.4 | 4.3 | 4.5 | 88.0 | 86.0 | 90.0 | 97.9 | 97.9 | 98.4 |
| 1,000 | 4.4 | 4.3 | 4.4 | 88.0 | 86.0 | 88.0 | 96.5 | 96.5 | 97.5 |
| 1,500 | 4.4 | 4.1 | 4.3 | 88.0 | 82.0 | 86.0 | 95.0 | 95.5 | 95.5 |
| 2,000 | 4.4 | 4.1 | 4.3 | 88.0 | 82.0 | 86.0 | 92.7 | 93.6 | 93.6 |
| 2,500 | 4.4 | 4.1 | 4.2 | 88.0 | 82.0 | 84.0 | 92.1 | 91.3 | 91.3 |
| 3,000 | 4.4 | 4.1 | 4.2 | 88.0 | 82.0 | 84.0 | 89.5 | 90.3 | 89.9 |
| 3,500 | 4.4 | 4.1 | 4.1 | 88.0 | 82.0 | 82.0 | — | 88.7 | 87.8 |
| 4,000 | 4.4 | 4.1 | 4.1 | 88.0 | 82.0 | 82.0 | 85.7 | 87.1 | 85.7 |
| 4,500 | 4.3 | 4.0 | 4.1 | 86.0 | 80.0 | 82.0 | 85.2 | 87.0 | 86.1 |
| 5,000 | 4.3 | 4.0 | 4.1 | 86.0 | 80.0 | 82.0 | 81.2 | 83.3 | 80.4 |
| 5,500 | 4.4 | 4.1 | 4.2 | 88.0 | 82.0 | 84.0 | 85.5 | 85.1 | 83.4 |
| 6,000 | 4.4 | 4.1 | 4.1 | 88.0 | 82.0 | 82.0 | 81.1 | 82.0 | 78.9 |
| 6,500 | 4.3 | 4.0 | 4.2 | 86.0 | 80.0 | 84.0 | 80.7 | 82.0 | 77.8 |
| 7,000 | 4.3 | 4.1 | 4.2 | 86.0 | 82.0 | 84.0 | 77.9 | 79.9 | 74.9 |
| 7,500 | 4.3 | 4.0 | 4.1 | 86.0 | 80.0 | 82.0 | 78.7 | 81.2 | 77.3 |
| 8,000 | 4.3 | 4.0 | 4.1 | 86.0 | 80.0 | 82.0 | 76.1 | 79.1 | 74.1 |
| 8,500 | 4.3 | 4.0 | 4.1 | 86.0 | 80.0 | 82.0 | 77.7 | 80.8 | 75.0 |
| 9,000 | 4.2 | 3.9 | 4.1 | 84.0 | 78.0 | 82.0 | 76.1 | 79.1 | 72.6 |
| 9,500 | 4.2 | 3.9 | 4.0 | 84.0 | 78.0 | 80.0 | 74.8 | 77.8 | 72.2 |
| 10,000 | 4.2 | 3.9 | 4.0 | 84.0 | 78.0 | 80.0 | 73.6 | 76.9 | 69.7 |

### Example 2

Composition of 1˜2 μm Carbon Blocks and the Manufacturing Method Powdered activated carbons with an average particle size ranging from 60˜102 μm are mixed with pulverized binders with a granularity of 20˜80 μm. The powdered activated carbons is 20˜30 wt % of the total amount of binders. The mixtures are compressed at approximately 3˜30 kgf/cm², and thermally processed at 220° C. for 40 minutes. After completing the processes, blocks with pores of approximately 1˜2 μm are produced.

Analysis Result
1. Removal rate of chloroform (%)

1) Used pulverized binders (Block size: 45×21.5×242), made in D company, R.O.K.
D company's binder-1 (SAMPLE 1): 94.8% (1500 liters)
D company's binder-2 (SAMPLE 2): 92.7% (1500 liters)

2) Used binders (Block size: 45×21.5×242), made in T company (Ticona, Germany)
T company's binder-1 (SAMPLE 1): 93.9% (1500 liters)
T company's binder-2 (SAMPLE 2): 93.9% (1500 liters)

Where T company's binder-2 refers to a block filter where T company's binders are mixed with commercial activated carbons.
2. Block pore test result.

TABLE 2

Removal efficiency (%)

| Particle | D Co.'s | D Co.' | T Co.'s | T Co.'s |
|---|---|---|---|---|
| size (μm) | binder-1 | binder-2 | binder-1 | binder-2 |
| 1 | 56.61 | 62.76 | 61.34 | 60.80 |
| 2 | 88.62 | 89.91 | 83.74 | 83.92 |
| 3 | 97.12 | 97.36 | 94.50 | 97.71 |

Removal rate: equal to or greater than 90%

### Example 3

Composition of 0.5 μm Carbon Blocks and the Manufacturing Method

Powdered activated carbons with an average particle size ranging from 60˜102 μm are mixed with pulverized binders with a granularity of 20˜80 μm. The powdered activated carbons is 20˜30 wt % of the total amount of binders. The mixtures are compressed at approximately 3˜30 kgf/cm², and thermally processed at 210° C. for 50 minutes. After completing the processes, blocks with pores of approximately 0.5 μm are produced.

Analysis Result
1. Removal rate of chloroform (%)

1) Used pulverized binders (Block size: 45×21.5×242), made in D company, R.O.K.
D company's binder-1 (SAMPLE 1): 98% (2000 liters)
D company's binder-2 (SAMPLE 2): 97% (2000 liters)

2) Used binders (Block size: 45×21.5×242), made in T company (Ticona, Germany)
T company's binder-1 (SAMPLE 1): 98% (2000 liters)
T company's binder-2 (SAMPLE 2): 98% (2000 liters)

Where T company's binder-1 and binder-2 refer to block filters where T company's binders are mixed with commercial activated carbons.
2. Block filter pore test result.

TABLE 3

Removal efficiency (%)

| Particle | D Co.'s | D Co.' | T Co.'s | T Co.'s |
|---|---|---|---|---|
| size (μm) | binder-1 | binder-2 | binder-1 | binder-2 |
| 1 | 94.95 | 95.05 | 98.33 | 98.33 |
| 2 | 98.20 | 97.97 | 99.02 | 99.98 |
| 3 | 99.06 | 98.86 | 99.41 | 99.36 |

Removal efficiency is equal to or greater than 90%. The pore is estimated 0.5 μm.

### Example 4

Composition of 5 μm Carbon Blocks and the Manufacturing Method

Powdered activated carbons with an average particle size ranging from 110˜140 μm are mixed with separated binders with a granularity of 110˜130 μm. The activated carbons is 5˜10 wt % of the total amount of binders. The mixtures are compressed at approximately 3˜30 kgf/cm², and thermally processed at 230° C. for 60 minutes. After completing the processes, blocks with pores of approximately 5 μm are produced.

If the amount of binders is less than 5 wt %, the structure of the blocks is week so dusts are created therefrom. If the amount of binders is greater than 10 wt %, the porosity is low.

Analysis Result
1. Block filter pore test result

TABLE 4

Removal efficiency (%)

| Particle size (μm) | D Co.'s binder-1 | D Co.' binder-2 |
|---|---|---|
| 4 | 88.51 | 84.45 |
| 5 | 93.97 | 91.51 |
| 6 | 96.93 | 95.55 |

Removal efficiency is equal to or greater than 90%.

As described above, the carbon blocks according to the invention have a high filtration performance as they are designed in such a way that the binders where the granularity of the binders is controlled are mixed with activated carbons at an optimal composition ratio.

The carbon blocks used for water purifiers, according to the invention, have pores of 0.5, 1˜3, and 5 μm, and the performance is tested. In addition, the binders, which have been imported from foreign counties, e.g., Germany and Japan, to the R.O.K., are produced 100% locally in the R.O.K., thereby acquiring import substitution effect and reducing the manufacturing cost by 30˜40% making them cost-effective in foreign counties.

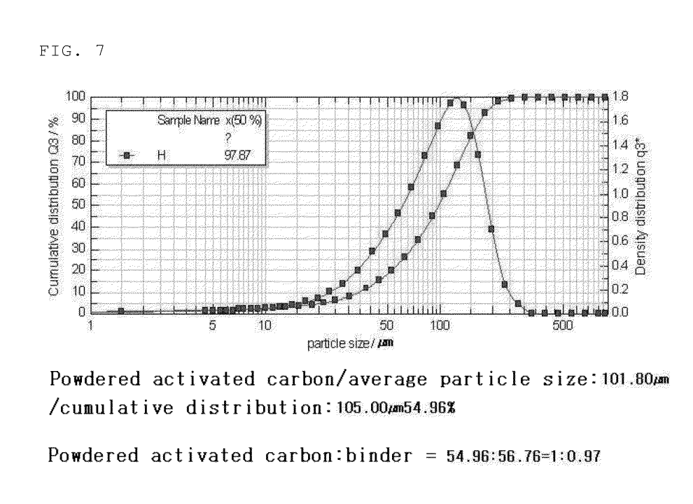

The average particle size of activated carbons used for the invention is approximately 60˜102 μm and 110˜140 μm. The average particle size of binders, made in Korea, is 120˜140 μm. As such, the activated carbons and the binders have different average particle sizes and also different granularity distributions. That is, the binders, made in Korea, have a peak curve in the granularity distribution graph and a smooth curve in the cumulative distribution graph as shown in FIG. 5, and the powdered activated carbons have a peak curve in the granularity distribution graph and a smooth curve in the cumulative distribution graph as shown in FIG. 7. The shapes of the curves between the binders and the powdered activated carbons differ from each other. Therefore, if they are used to manufacture a carbon block filter, the dust is separated from the activated carbons and accordingly this deteriorates the filtration performance of the carbon block filter, which is similar to conventional filters. In order to resolve this problem, the invention performs the following processes: the original binders where the average particle size ranges from 120˜140 μm are pulverized; binders where the average particle size ranges from 20˜80 μm are separated from the pulverized original binders; the separated binders are mixed with the original binders where the average particle size ranges from 120˜140 μm at a certain ratio; and the optimal cumulative distribution ratio of ultra high molecular weight polyethylene (UHMWPE) binders and activated carbons is 1:0.78˜1.1, with respect to the particle size equal to or less than 105 μm. If the cumulative distribution ratio is less than 0.78, the dust of activated carbons leaks from the carbon block filter. If the cumulative distribution ratio is greater than 1.1, the rate of passing water is low. It is preferable that, as shown in FIG. 6, the cumulative distribution rate of activated carbons equal to or less than 105 μm is 54.96% and the cumulative distribution rate of binders where the granularity is controlled to be equal to or less than 0.5 μm is 56.76%. Therefore, the ratio therebetween is calculated as 1:1.03 which is within the following ratio equation.

The cumulative distribution rate of the powdered activated carbons to the binders where the granularity is controlled to be equal to or less than 105 μm is 1 (cumulative distribution rate of activated carbons is equal to or less than 105 μm as shown in FIG. 7): 0.78˜1.1 (cumulative distribution rate of binders where the granularity is controlled to be equal to or less than 105 μm as shown in FIG. 6).

Where 1:0.78˜1=54.96%: 56.76%=1:1.03

This allows for the production of the optimal granularity ratio of activated carbons to binders.

UHMWPE binders with an average granularity of 120˜140 μm, made in Korea, serving as the original binders, are pulverized via a ball mill and an agent mill, and sorted into particles of sizes via a vibratory sieve shaker with mesh equal to or less than 100 μm. The separated binders have a granularity of 20˜80 μm.

In order to equalize the granularity between the powdered activated carbons where the granularity is controlled to be 60˜102 μm and 110 and 140 μm and the binders made in Korea, the original binders are pulverized to acquire the binders, separated from the original pulverized binders. The separated binders with a granularity of 20˜80 μm are mixed with the original binders with an average granularity of 120˜140 μm at a certain ratio, i.e., an optimal composing ratio.

The carbon block filter according to the invention is designed in such a way that the pore has a size of 0.5 μm, 1˜3 μm, and 5 μm, which is commonly adopted in water purifiers. In order to estimate the filtration performance of the carbon block filter, it is scanned by a scanning electron microscope (SEM), and measured in terms of the rate of passing water, the adsorption of chloroform, and the pore size. The carbon block filter according to the invention is compared, in terms of the filtration performance, with conventional filters using binders made in Ticona, Germany.

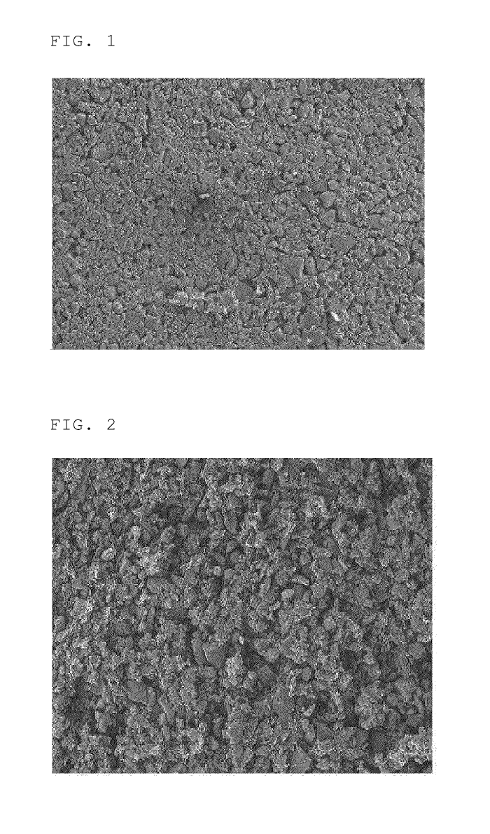

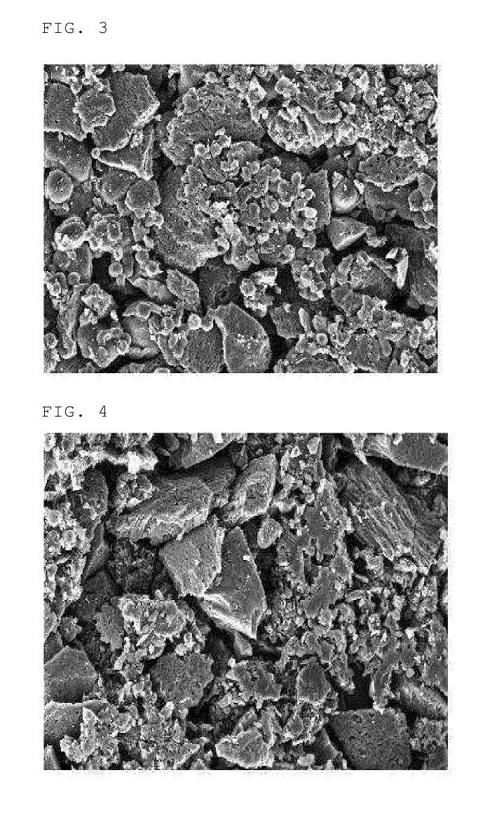

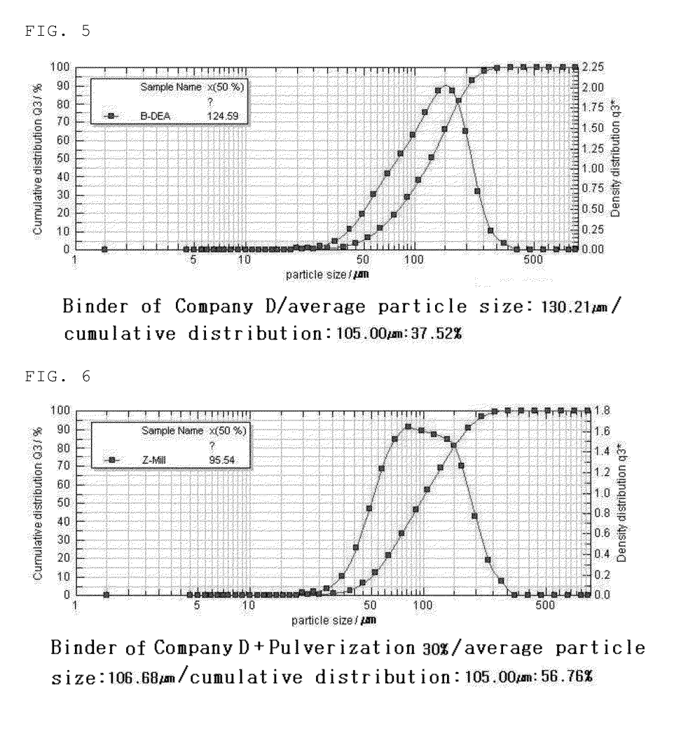

The surface of the carbon block filter according to the invention, scanned via SEM, is shown in FIGS. 1 to 4. The surface of the block filter that includes pulverized binders, made in D company, Korea, as shown in FIGS. 1 and 3, is denser and smoother than that of the block filter that includes binders, made in T company, Germany, as shown in FIGS. 2 and 4. FIGS. 3 and 4 illustrate photographs of enlarged carbon blocks to check whether melted binders reduce the surface area of activated carbons. FIGS. 3 and 4 show that the surface area of activated carbons is not coated with melted binders.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

What is claimed is:

1. A carbon block filter manufacturing method comprising:
pulverizing ultrahigh molecular weight polyethylene (UHMWPE) binders with the average particle size of 120˜140 μm, serving as original binders, and separating binders with the granularity of 20˜80 μm from the original binders;
mixing the separated binders with the original binders; and
forming a carbon block filter by mixing commercial, powdered activated carbons, with the mixed binders,
wherein the mixing of the separated binders with the original binders and the forming of the carbon block filter control the powdered activated carbons and the adjusted, UHMWPE binders so that the cumulative granularity ratio of them is 1:0.78˜1.1, with respect to a particle size equal to or less than 105 μm.

2. The method of claim 1, wherein the mixing of the separated binders with the original binders comprises:
adding the separated binders of 20˜80 μm, the total binder of 10˜40 weight %, to the original binders.

3. The method of claim 1, wherein the mixing of the separated binders with the original binders comprises:
adding the separated binders of 110˜130 μm, the total binder of 5˜10 weight %, to the original binders.

4. A carbon block filter comprising:
ultrahigh molecular weight polyethylene (UHMWPE) binders and powdered activated carbons where the granularity is controlled,
wherein the powdered activated carbons are mixed with the ultrahigh molecular weight polyethylene (UHMWPE) binders so that the cumulative granularity ratio of them is 1:0.78˜1.1, with respect to a particle size equal to or less than 105 μm.

5. The carbon block filter of claim 4, wherein:
the powdered activated carbons have an average particle size that ranges from 60˜102 μm;
the UHMWPE binders are formed in such a way that pulverized binders with a granularity of 20˜80 μm, 10˜20 wt %, are mixed with original binders with a range of average particle size of 120˜140 μm, 80˜90 wt %; and
the carbon block filter has a porosity of 3 μm.

6. The carbon block filter of claim 4, wherein:
the powdered activated carbons have an average particle size that ranges from 60˜102 μm;
the UHMWPE binders are formed in such a way that pulverized binders with a granularity of 20˜80 μm, 20˜30 wt %, are mixed with original binders with a range of average particle size of 120˜140 μm, 70˜80 wt %; and
the carbon block filter has a porosity of 1˜2 μm.

7. The carbon block filter of claim 4, wherein:
the powdered activated carbons have an average particle size that ranges from 60˜102 μm;
the UHMWPE binders are formed in such a way that pulverized binders with a granularity of 20˜80 μm, 30˜40 wt %, are mixed with original binders with a range of average particle size of 120˜140 μm, 60˜70 wt %; and
the carbon block filter has a porosity of 0.5 μm.

8. The carbon block filter of claim 4, wherein:
the powdered activated carbons have an average particle size that ranges from 110˜140 μm;
the UHMWPE binders are formed in such a way that pulverized binders with a granularity of 110˜130 μm, 5˜10 wt %, are mixed with original binders with a range of average particle size of 120˜140 μm, 90˜95 wt %; and
the carbon block filter has a porosity of 5 μm.
